(19) United States
(12) Patent Application Publication
(10) Pub. No.: US 2002/0187337 A1
(43) Pub. Date: Dec. 12, 2002

(54) Pitch coated board and method of manufacture

(76) Inventors: David Chris Boyer, Huntington, WV (US); Melvin D. Kiser, Huntington, WV (US); Stephen E. See, Wheelersburg, OH (US)

Correspondence Address: RICHARD D. STONE, MARATHON ASHLAND PETROLEUM LLC, 539 SOUTH MAIN STREET, FINDLAY, OH, 45840, US

(21) Appl. No.: 10/109,343

(22) Filed: Mar. 28, 2002

Related U.S. Application Data
(60) Provisional application No. 60/280,250, filed on Mar. 30, 2001.

(51) Int. Cl. B32B 5/14

(52) U.S. Cl. 428/332; 428/308.8; 428/491; 156/337; 156/242

(57) ABSTRACT

A pitch coated board and method of manufacture are disclosed. A porous or fibrous material, is coated and partially impregnated with a thin layer, less than 10 mil in thickness, of a petroleum or coal tar pitch. A high softening point, above 200F, coal tar or petroleum pitch is heated, then preferably roller coated on a fibrous material, then cooled within 1-2 seconds or less, to produce the pitch coated material. The porous material may be heated, preferably superficially, prior to application of the pitch to facilitate some penetration.

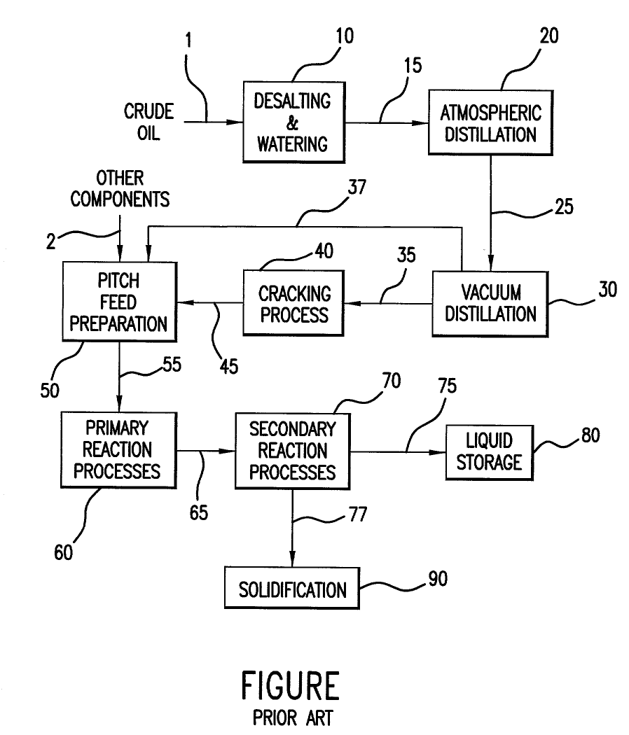

### FIELD OF THE INVENTION

The invention relates to porous board or fibrous materials coated with a thin layer of pitch.

### BACKGROUND OF THE INVENTION

Use of boards to build things, and pitch to coat them, has occurred for thousands of years. Boats and dwellings have been built of boards or planks. In order to keep water out, small joints, cracks or imperfections in the boards have been coated with pitch materials. Early people were able to create pitch from wood tar or sap, by heating until sufficient thermally induced polymerization had occurred to create the pitch. A somewhat related sealing approach was used by residents near the Lake Athabasca tar sands deposits, though this material was asphaltic and not a true pitch material.

To make the supply of scarce timber products go further and/or to improve strength, modem wood products are made from wood fibers, multiple plies of thin strips of wood (plywood) or from chips of wood glued together (particle board).

Some boards are made from wood fiber or “wood strips” very, very thin strips of wood. These are wood fibers not necessarily a strip of wood.

These materials have the advantage, respectively, of greater strength and low cost. All fibrous materials, such as wood planks, plywood and particle board, are susceptible to attack from water. To resist water, workers have applied wax, paint, oil, tar, and the like.

In some applications, such as roofing made with particle board to which an adhesive and a roll felt material is applied, there is little need for waterproofing so much as there is a need to reduce the amount of glue or adhesive which will penetrate the board surface. Excess penetration consumes excessive amounts of glue, requires a long drying time and can weaken the board. The board can be weakened by, e.g., dissolution of the glue binding the particle board together. To reduce glue penetration into particle board, manufacturers have resorted to adding small and large amounts of asphalt to the board. Small amounts of asphalt, and even of pitch, have been blended in with the starting material, in the hope that the presence of asphalt/pitch will serve both as a board binder and as a sealer to reduce penetration of glue. Small amounts of asphalt, usually diluted with solvent, have been sprayed on particle board, to permit a limited amount of asphalt sealer to soak into the board. Small amounts are typically used to minimize the amount of sticky asphaltic material that is on the top of the board, because this material can cause a stack of boards to stick together or to the hands and clothing of workers applying the material. Some attempts are believed to have been made to apply larger amounts of a high softening point asphalt. Such a heavy coating will effectively waterproof particleboard, but it requires a long drying time and a solvent. Some representative patents are reviewed hereafter and incorporated herein by reference.

U.S. Pat. No. 4,364,975, METHOD OF AND APPARATUS FOR PRODUCING ASPHALT SATURATED FIBERBOARD, taught placing a rack containing fiberboards in a tank into which a solution of solvent and asphalt is pumped, then removed.

U.S. Pat. No. 3,856,657, OXIDIZED PETROLEUM PITCH, taught batchwise oxidation of an aromatic stream to make pitch. The pitch was useful for binder pitch, fiberboard pitch and pipe saturates.

U.S. Pat. No. 4,202,755 Spiegelman, et al. May 13, 1980, CATALYTIC METHOD FOR MAKING PITCH, taught a method for making pitch from petroleum bottoms fractions by air blowing in the presence of about 1 percent by weight of metallic sodium. The method reduces processing time by about one-third and the product is of the desired high density of about 1.25 g/ml. to above 1.30 g/ml. at 25° C.

U.S. Pat. No. 3,607,486, PROCESS FOR MAKING WATER REPELLENT PAPER AND GYPSUM SHEATING BOARD AND A COATING COMPOSITION USEFUL THEREIN, disclosed use of aqueous asphalt emulsion and an organic solvent to make a water repellent gypsum sheathing board.

We were concerned about the shortcomings of the traditional methods of waterproofing particleboard. Although the methods worked, to a greater or lesser extent, they either required a lot of time (to dry) or did a poor job (of waterproofing). The approaches, with asphalt at least, involved a solvent, the evaporation of which leads to significant amounts of volatile organic compounds, which can be a significant contributor to air pollution. We wanted to develop a new fiberboard, and a method of manufacturing it, which would greatly reduce or eliminate the amount of solvent needed to get the waterproofing material on the board. We wanted to develop a coating process which could be incorporated into or near the point of manufacture of the particle board and which did not require excessive drying time nor prevent conventional handling (e.g., stacking) of the particle board.

We wanted to develop a board with a pleasing appearance. We also wanted to develop a coating that would lend itself to imprinting, something like a watermark, so that a makers mark could be permanently affixed to the board for identification purposes.

We discovered that it was possible, using a glassy substance, to provide a superb waterproofing coating which could be nailed without shattering and which required much less, or even no, solvent. We discovered that pitch, preferably petroleum pitch with a softening point above that of boiling water, could be applied and dried in less than a second, especially when the preferred roller coating technique of pitch application was used.

### BRIEF SUMMARY OF THE INVENTION

Accordingly, the present invention provides a rigid or at least semi-rigid porous board or fibrous material having a surface coating of less than 10 mil thickness of a petroleum or coal tar pitch, and wherein said pitch is a brittle, glassy solid at ambient temperature and at least a portion of said pitch penetrates into said porous board or fibrous material.

In another embodiment, the present invention provides a method of coating fiberboard or particleboard with a high softening point pitch material comprising applying a surface coating of molten pitch at a temperature and in an amount sufficient to allow at least 10% of the pitch to flow into the porous surface and wherein the total thickness of said pitch is less than 10 mil.

### BRIEF DESCRIPTION OF THE DRAWING

The FIGURE (Prior Art) is a simplified, block flow diagram of conventional pitch production.

### DETAILED DESCRIPTION OF PREFERRED EMBODIMENTS

The present invention involves a pitch coating on a fibrous board and an efficient method of applying the coating. Each aspect (pitch, board and application) will be reviewed in turn. PITCH

The present invention requires the use of pitch, a pitch that is a glassy solid at room temperature. A suitable material will, if heated and poured onto a surface in the form of a thin layer a few mm thick, form a brittle glassy solid which can be shattered if hit. The material preferably has a softening point above that of boiling water. Such pitch materials are the result of thermal polymerization of an aromatic feedstock material. Wood pitch, at least as produced in Biblical times, is generally not suitable because too many impurities remain in the primitive manufacturing processes used. Coal tar pitch, a by-product of the destructive distillation of coal or coking of coal, may be used with good results. Especially preferred is petroleum pitch, a staple article of commerce available from multiple vendors. Petroleum pitch is the product of thermally induced polymerization of aromatic streams, with distillation to remove lighter boiling components. An advantage of petroleum pitch, over other commercially available pitches, is a significantly lower level of un-substituted, polynuclear aromatic hydrocarbons, making petroleum pitch a much more benign material environmentally.

Coal tar and petroleum pitches, per se, are well known and widely used materials, available from multiple manufacturers. Methods of coal tar and petroleum pitch production are discussed in(R. A. Wombles, M. D. Kiser, “Developing Coal Tar/Petroleum Pitches”, Light Metals, 2000, The Minerals, Metals and Materials Society, Warrendale, Pa., March 2000, pp 537-541, which is incorporated by reference.

Coal tar is a by-product of the coking of coal to produce metallurgical coke. Coal is heated to a temperature of approximately 1100° C. in a coke oven to produce coke (the primary product) and by-products such as coke oven gas, coal tar light oil, and coal tar. Typical yields are 70% solid products and 30% liquid products. The yield of coal tar, the feedstock for producing coal tar pitch, from a ton of coal is 3045 liters (8-12 gallons). Coal tar pitch has many uses, but the majority of the pitch produced is used as a binder for petroleum coke to produce anodes and graphite electrodes. Coal tar pitch is produced by the distillation of coal tar.

Many petroleum products are referred to as “pitch” by the petroleum industry. This fact has the potential to cause considerable confusion outside the refining community. In most cases, the different types of petroleum pitch share only the commonality of being black solids at room temperature. The individual characteristics of petroleum pitches vary as functions of feedstock and the specific processes used in their manufacture. Feedstocks can range from a predominantly aliphatic to predominantly aromatic type chemical structure. A reaction step is used to generate and/or concentrate the large molecules typically observed in petroleum pitch. The most common processes used to generate petroleum pitches are singularly or a combination of (a) solvent deasphalting, (b) oxidation, and (c) thermal processes.

Solvent deasphalting is used to separate fractions of various heavy oils. Solvent deasphalting involves mixing the feedstock with a paraffinic solvent such as propane, butane, or pentane. The mixing of the feedstock with these light paraffinic solvents causes precipitations of the molecules with higher molecular weights and aromaticities. The chemical and physical properties of this type of petroleum “pitch” are more closely associated with asphalt cements used for road paving. Typical properties include a specific gravity of approximately 1.0 g/cc at 60° F., with the chemical composition containing significant amounts of non-aromatic hydrocarbons and high levels of iron, nickel, and vanadium.

Various grades of pitch can be produced by the oxidation of heavy petroleum hydrocarbons. Although oxygen is used in the process, the products typically do not contain significant amounts of oxygen. During this reaction, the presence of oxygen is successful in generating free radicals that induce polymerization reactions. The chemical properties of these products will depend upon the starting material and degree of reaction, but the pitches produced typically have low coking values and high viscosity.

Thermal processing is used to produce petroleum pitch as noted in several patents listed below and incorporated by reference.

Bell, J. F., et al. (assigned to Socony Mobil Oil Company), U.S. Pat. No. 3,140,248.

Alexander, et al., U.S. Pat. No. 3,537,976.

Seinfeld et al., U.S. Pat. No. 3,856,657, Oxidized Petroleum Pitch.

D. Blakeburn II, et al., (assigned to Conoco), U.S. Pat. No. 4,959,139, Binder Pitch and Method of Preparation.

Thermal processing has traditionally been used to produce the high specific gravity and aromaticity petroleum pitches referred to in the introduction. The thermal processes cited in the literature typically employ heat treatment temperatures in the range from 300 to 480° C.

A typical flow scheme for producing petroleum pitch from crude oil is given in the FIGURE. Crude oil is charged via line 1 to desalting and dewatering means 10. The crude oil is then charged via line 15 to atmospheric distillation means 20 and via line 25 a heavy fraction charged to vacuum distillation means 30. A portion of the vacuum distilled crude is charged via line 35 to a cracking process 40, typically fluidized catalytic cracking, from which a fraction is charged via line 45 to pitch feed preparation means 50. A portion of the liquid product of vacuum distillation means 30 may also be charged via line 37 directly to pitch feed prep unit 50. Other components may be added via line 2 to pitch feed preparation unit 50. The pitch feed is then charged via line 55 to primary and secondary reaction processes in vessels 60 and 70, respectively with pitch flowing from primary reaction process 60 to the secondary process 70 via line 65. Liquid pitch may be charged via line 75 to liquid storage means 80 or charged via line 77 to solidification means 90.

As used in the FIGURE, feed preparation can consist of any one, or a combination of, blending, distillation, desulfurization and solids removal. Primary reaction processes may consist of any one, or a combination of, solvent deasphalting, thermal processing, oxidation or catalytic reactions. Secondary reaction processes may include distillation, desulfurization, oxidation or thermal soaking.

The pitch, whether petroleum or coal tar derived, may be produced with a relatively low and desired softening point by running the distillation process to keep some liquids in to act as a solvent or softener. Alternatively, or in addition to sloppy distillation, a high softening point pitch may be produced and then mixed with a solvent to reduce its softening point to a desired level.

Pitch Properties:

Petroleum pitch has the following reportable compounds

Components: (wt %)

| | |
|---|---|
| Sulfur Compounds | 0.50-4.00 |
| (Expressed as wt % sulfur) | |
| Benzo(a)pyrene | 0.10-0.30 |
| Benz(a)athracene | 0.10-0.30 |
| Indeno1,2,3-cd)pyrene | 0.01-0.20 |

Properties for two types of preferred commercial petroleum pitches (Marathon Ashland Petroleum LLC A-240 and A-225) are detailed in the following table.

| | | | Typical Properties | |
|---|---|---|---|---|
| | | Test | Product | Product |
| Property | | Method | A 240 | A 225 |
| Softening Point, ° C. (° F.) | | ASTM | 118-124° C. | 108-113° C. |
| | | D 3104 | 244-255° F. | 226-235° F. |
| Ash, wt | | ASTM | 0.2 max | 0.2 max |
| | | D 2415 | | |
| Density, g/cc | | ASTM | 1.20 mm | 1.20 mm |
| | | D 4892 | | |
| Viscosity, absolute | | ASTM | | |
| ° C. | ° F. | D 4402 | | |
| 135 | 275 | (Brookfield) | — | 13,930 |
| 150 | 302 | | 8,940 | 2,309 |
| 175 | 347 | | 738 | 309 |
| 200 | 392 | | 149 | 80 |
| 225 | 437 | | 49.4 | 31.2 |

Some general comments on preferred pitch properties, differences between pitch and asphalt, and pitch properties which are not critical, follow. Softening point and viscosity affect the flow properties and how well or how poorly the pitch coats the board and fills in the imperfections. A softening point range of 108 to 124° C. (226 to 255° F.) works well.

The density value is a good way to distinguish between pitch and asphalt products. Asphalt products will have a density between 1 and 1.1 g/cc, whereas, pitch products have a density greater than 1.20 g/cc.

Ash content of asphalt will normally be higher than pitch. The 0.2 wt % value included is sufficient to include most coal tar pitches as well as the petroleum pitches. If petroleum pitch is used, it is possible to use 0.1 wt % maximum ash.

Other properties such as sulfur, toluene insolubles, quinoline insolubles are not critical to this application.

Although use of essentially pure petroleum pitch is preferred, it is possible to add other materials, such as solvents, asphaltic fractions, and the like, but generally results will not be as good as when pure petroleum pitch is used. Preferably the glassy solid pitch component comprises a majority of the coating on the board, with other components, such as solvents, cut back oils, asphaltic fractions, comprising less than 50%. In this way the rapid drying chraracteristics, and low environmental impact, a petroleum pitch may be retained.

Fibrous Board

The board can be any fibrous, relatively porous material. Usually the board will be made of a complex mix of chips and slivers, in the form of “particle board,” or a fiberboard, both of which are well known and widely used. In some applications, the board constituent will be more finely ground, so that no large particles of wood are evident. Such materials, sometimes termed “Masonite board” or “peg board,” have a density greater than wood and relatively low strength, at least in regards to flexing. Relatively heavy paper products, such as cardboard, may require a waterproof coating and may be used herein.

Pitch Application

Any method can be used which will incorporate a relatively uniform and thin layer of pitch material. This may be done by spraying, brushing or dipping usually followed by some sort of post treatment to reduce the amount of material to the desired thin layer. A thin layer is essential both to reduce cost and drying/cooling time and, more importantly, to ensure that the coating becomes an integral part of the board and will not break excessively when hit with a hammer or subjected to the indignities which construction material commonly experiences.

The ideal way to apply the pitch is to roller coat it. The roller coating equipment can be conventional, though heating is essential to maintain the pitch in a molten state. The process can be operated to produce a coating less than 10 mm in thickness, preferably less than 5 mm in thickness, more preferably less than 3 mm in thickness and most preferably 2 mm or even 1 mm or even less. The maximum thickness is set to some extent by economics, in that excess amounts of pitch are used if the coating is too thick. Another constraint on thickness is cooling time and mess. The most significant constraint is applying the coating in such a way that a significant portion of the pitch actually soaks into the wood or other porous material and binds with it. This allows a glassy material (solidified pitch) to be firmly affixed to a porous, somewhat flexible material (fiberboard) and for nails or other fasteners to be driven through the board without undue damage. By avoiding undue damage we mean that the nail or fastener can be driven through and the amount of flaking or shattering of the glassy pitch material will be minimal, leaving a hole no more than twice the diameter of the object penetrating the board. Ideally, the nail or other fastener can be driven in the board, to a depth where the head of the nail or fastener is flush with the surface of the board, and surface of the board will remain substantially intact, save for the actual surface of the fastening device.

Fine Tuning

Preferably, the board is relatively cool, having an average temperature below 200F, preferably below 150F., and most preferably below 100F, and ideally is at or near ambient room temperature. This relatively cool board is then heated, by a heat lamp, radiant element, hot air blower or the like. Preferably, the surface heating occurs immediately prior to roll coating of the pitch, to ensure that the top of the board is somewhat heated but the inner portions of the board are relatively cool. This superficial heating allows some of the pitch to flow into and around the porous material, but as the pitch penetrates the board the pitch encounters cooler substrate and thickens. Other fine tuning is possible by changing the heating of the pitch, the pressure of the pitch roller, and/or adding a solvent or using a pitch with a different softening point. In general, the roller much be heated enough to maintain the pitch in a completely molten and fluid state. When neat A-240 petroleum pitch is used, the pitch coating rollers should be maintained at a temperature such that the temperature will provide a viscosity of the pitch less than 1,000 centipoise, most preferably a viscosity of ≈700 centipoise. In the case of Marathon Ashland A-240 petroleum pitch, the desired temperature is ≈350° F.

The optimum temperature will vary depending on the viscosity of the pitch coating. The viscosity properties of typical coal tar pitches are different than A-240, therefore use of viscosity rather than roller temperature will be more inclusive. Viscosity is a key parameter for successfully application, so use of viscosity values, rather than specific temperature ranges, is preferred.

Preferably, the amount of pitch, and the heating of the board and pitch pool coating the board and the temperature of the roller, are set so that the pitch hardens within 10″ of leaving the roller, preferably 5″, more preferably within 2″, and most preferably within 1″ of leaving the roller. Preferably the pitch is used “neat,” without any solvent other than the residual liquid hydrocarbon oils present in the “as purchased” pitch. There will be some VOC emission even from this material, but it will be far less hydrocarbon emission than would occur using conventional approaches, such as large amounts of a volatile solvent. Suitable roller coating equipment is made by the Union Tool Corporation, Warsaw, Ind., which provides roll coaters with stainless steel rollers. These rollers are available with and without silicon rubber coating, but we prefer to use the stainless steel rollers without a coating.

Experiments:

A commercial roll coater was used to coat commercial grade fiberboard with petroleum pitch. These roll coaters are normally used for the application of adhesives in the production of plywood. A series of coating tests were conducted with the goal of determining flexibility of application and determination of critical variables. This type of coater was capable of precise temperature, pressure, and line speed controls and could be equipped with either stainless steel or silicon rubber coated rolls. Based on the viscosity of the pitch, a starting temperature of 350° F. was used. A temperature differential of ≈25° F. was observed between the center and the surface of the rollers.

Adjustments in roller temperature were made to provide for a roll surface temperature of ≈350° F. A series of boards were coated on both sides with favorable results. As shown in Table I, the amount of A-240 coated on the boards was consistent with a good appearance. Few flaws were observed, with most flaws from surface flaws in the original board. All boards were coated with the board being at ambient temperature as it was fed into the roll coater. Drying time was extremely fast. Based on appearance and touch, the board was dry within 1-2 inches from the roller. It appears that if boards are fed into the rollcoater at ambient temperature such as in an off-line operation, the boards could be stacked on pallets without a long drying time.

TABLE I
Consistency of Pitch Coating on Commercial Fiberboard

| Board # | Grams/ft² |
|---|---|
| 1 | 5.7 |
| 2 | 5.8 |
| 3 | 4.0 |
| 4 | 5.2 |
| 5 | 4.8 |
| 6 | 4.9 |
| 7 | 5.9 |
| 8 | 4.2 |
| 9 | 3.7 |
| 10 | 4.7 |
| 11 | 5.4 |
| 12 | 5.6 |
| 13 | 5.0 |
| Average | 5.0 |
| Minimum | 3.7 |
| Maximum | 5.9 |
| Standard Deviation | 0.7 |

Results

The following observations from this experimentation were made:

Board Coating—Fiberboards were successfully coated with petroleum pitch consistently at a coating level of 5±2 grams per square foot (≈2 mil thickness).

Thickness—Thick coatings (>20 grams per square foot or 5 mil thickness) caused excessive dripping on the edge of the board.

Drying Time—When even coating was obtained, the drying time of the pitch on the board was less than 2 seconds.

Pitch Viscosity—The viscosity of the pitch during coating appears to be very critical. The viscosity of the pitch must be low enough to allow adsorption into the pores of the wood fibers. If the viscosity of the pitch at the surface is too high, the pitch will form a layer at the surface and simply flake off.

Temperature—Temperatures (rollers, boards, etc). must be controlled precisely as small temperature fluctuations will cause significant changes in pitch viscosity.

Pressure—The amount of pitch applied to the boards can be affected by pressure.

While the results reported in Table I were based on the use of pure petroleum pitch, it is possible to add small amounts of other pitches (coal tar, wood tar based), or other heavy materials which are normally solid at room temperature, e.g., tar sands, asphaltic fractions obtained by distillation or solvent extraction and the like. For rapid drying time, low or no solvent fume problems and concerns about toxicity/carcinogens, pure petroleum pitch is the preferred product.

We claim:

1 A rigid or at least semi-rigid porous board or fibrous material having a surface coating of less than 10 mil thickness of a petroleum or coal tar pitch, and wherein said pitch is a brittle, glassy solid at ambient temperature and at least a portion of said pitch penetrates into said porous board or fibrous material.

2 The material of claim 1 wherein said porous board is cardboard.

3 The material of claim 1 wherein the surface coating is less than 5 mil in thickness.

4 The material of claim 1 wherein the surface coating is less than 2 mil in thickness.

5 The material of claim 1 wherein the surface coating is 1 to 2 mil in thickness.

6 The material of claim 1 wherein the pitch material used is an organic glass which would shatter by itself but bonds with said rigid or semi-rigid porous board or fibrous material to permit working of the material without significant damage to the coated surface.

7 The material of claim 1 wherein the pitch has a softening point above 200F, is brittle as a neat sample at room temperature, and is applied at conditions sufficient to ensure a sufficiently thin coating, and penetration of said coating into said porous surface, to prevent shattering when screws, nails, staples or other fastening means are driven into said porous board or fibrous material.

8 A method of coating a porous surface with a high softening point pitch material comprising applying a surface coating of molten pitch at a temperature and in an amount sufficient to allow at least 10% of the pitch to flow into the porous surface and wherein the total thickness of said pitch is less than 10 mil.

9 The method of claim 8 wherein said porous surface is fiberboard or particleboard.

10 The method of claim 8 wherein a roller coating apparatus is used.

11 The method of claim 8 wherein the porous surface is heated to dry it, cooled at least 20° C. below the softening point of the pitch, the pitch is heated to a temperature 5 to 50° C. above its softening point and applied to said board.

12 The method of claim 8 wherein said pitch is applied without additional solvent, other than solvent in the as-purchased high softening point pitch product, and the molten pitch solidifies within 1 second of application.

13 The method of claim 8 wherein said porous surface is cardboard.

14 The method of claim 8 wherein the surface coating is less than 5 mil in thickness.

15 The method of claim 9 wherein the surface coating is less than 2 mil in thickness.

16 The method of claim 8 wherein the surface coating is 1 to 2 mil in thickness.

17 The method of claim 8 wherein the pitch material used is an organic glass which would shatter by itself but bonds with said rigid or semi-rigid porous board or fibrous material to permit working of the material without significant damage to the coated surface.

18 The method of claim 8 wherein the pitch has a softening point above 200F, is brittle as a neat sample at room temperature, and is applied at conditions sufficient to ensure a sufficiently thin coating, and penetration of said coating into s aid porous surface, to prevent shattering when screws, nails, staples or other fastening means are driven into said porous board or fibrous material.

19 The method of claim 8 wherein said porous surface is heated by radiant heating, convection, or brief surface contact so that said surface, but only the surface of said board, is heated sufficiently to allow a molten pitch to flow into said porous material, then encounter a cooler substrate of said porous material and thicken.

20 The method of claim 8 wherein said pitch is heated, prior to application thereof to said porous surface, to a temperature sufficient to reduce the viscosity of said pitch to less than 1,000 centipoise.
